(19) United States
(12) Patent Application Publication
(10) Pub. No.: US 2016/0245168 A1
(43) Pub. Date: Aug. 25, 2016

(54) ROCKER VALVE ADJUSTMENT COVER

(71) Applicant: Casey Longstreth, Kalispell, MT (US)

(72) Inventor: Casey Longstreth, Kalispell, MT (US)

(21) Appl. No.: 14/626,556

(22) Filed: Feb. 19, 2015

(51) Int. Cl. F02B 77/00

(52) U.S. Cl. CPC F02B 77/00

(57) ABSTRACT

A rocker valve adjustment cover for placement on an engine over its valves when the valves are to be adjusted to prevent spills and sprays during adjustments. The rocker valve adjustment cover comprises a base cover defining a rigid, five sided enclosure having adjustment holes and a plurality of removable plugs, each constructed of an elastic material and adapted to selectively seal a single adjustment hole. Each adjustment hole defines a discrete circular aperture in the top surface of the base cover, positioned to correspond to the alignment of a discrete rocker cover on a conventional engine. The base cover additionally includes a bottom rolled edge that defines its bottom profile, extending out from its side surfaces and including four cinch holes that may be used to attach the base cover to an engine.

### BACKGROUND OF THE INVENTION

1. Field of the Invention

This invention relates generally to internal combustion engine accessories and, more particularly, to a rocker valve cover configured to enable adjustment of valves while the vehicle is running

2. Description of the Prior Art

It is well known that for many internal combustion engines, the best time to adjust (and/or tune) the valves is while the engine is running. A problem which still exists, however, is that the process of adjusting engine valves while an engine is running often leads to oil spills and sprays. Thus, there remains a need for a rocker valve adjustment cover which could be placed over an engine while valves are being adjusted to prevent such spills and sprays. It would be helpful if such a rocker valve adjustment cover included a plurality of discrete adjustment holes positioned to correspond with discrete engine valves. It would be additionally desirable for such a rocker valve adjustment cover included a discrete, removable plug for each adjustment hole so that a any valve can be adjusted without exposing the other valves.

The Applicant's invention described herein provides for a rocker valve adjustment cover adapted be placed over an engine when it is desired to perform rocker valve adjustments. The primary components in Applicant's rocker valve adjustment cover are a cover body and a plurality of removable plugs. When in operation, the rocker valve adjustment cover enables a user to selectively access discrete rocker valves on an engine while the remaining valves remain covered. As a result, many of the limitations imposed by prior art structures are removed.

### SUMMARY OF THE INVENTION

A rocker valve adjustment cover for placement on an engine over its valves when the valves are to be adjusted to prevent spills and sprays during adjustments. The rocker valve adjustment cover comprises a base cover defining a rigid, five sided enclosure having adjustment holes and a plurality of removable plugs, each constructed of an elastic material and adapted to selectively seal a single adjustment hole. Each adjustment hole defines a discrete circular aperture in the top surface of the base cover, positioned to correspond to the alignment of a discrete rocker cover on a conventional engine. The base cover additionally includes a bottom rolled edge that defines its bottom profile, extending out from its side surfaces and including four cinch holes that may be used to attach the base cover to an engine.

It is an object of this invention to provide a rocker valve adjustment cover which could be placed over an engine while valves are being adjusted to prevent such spills and sprays.

It is another object of this invention to provide a rocker valve adjustment cover that includes a plurality of discrete adjustment holes positioned to correspond with discrete engine valves.

It is yet another object of this invention to provide a rocker valve adjustment cover that includes a discrete, removable plug for each adjustment hole so that a any valve can be adjusted without exposing the other valves.

These and other objects will be apparent to one of skill in the art.

### BRIEF DESCRIPTION OF THE DRAWINGS

FIG. 1 is a side perspective view of the base cover of a rocker valve adjustment cover built in accordance with the present invention.

FIG. 2 is a top plan view of the base cover of a rocker valve adjustment cover built in accordance with the present invention.

FIG. 3 is a bottom plan view of the base cover of a rocker valve adjustment cover built in accordance with the present invention.

FIG. 4 is a side elevational view of a removable plug of a rocker valve adjustment cover built in accordance with the present invention.

### DETAILED DESCRIPTION OF THE INVENTION

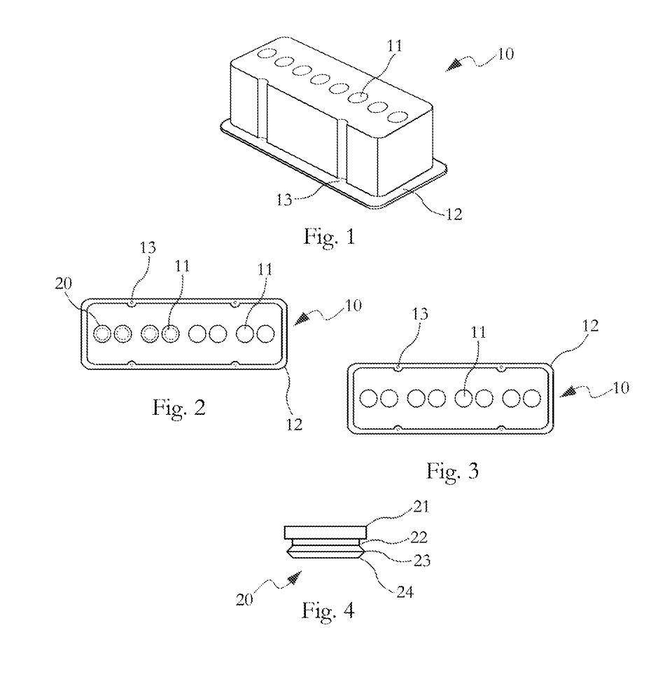

Referring now to the drawings and in particular FIGS. 1, 2, 3, and 4, a rocker valve adjustment cover is shown as a base cover 10 and a plurality of removable plugs 20. The base cover defines a rigid, five sided enclosure having adjustment holes 11 positioned on its top surface. Each adjustment hole 11 defines a discrete circular aperture in the top surface of the base cover 10 that with a 1″ diameter in the preferred embodiment and is positioned to correspond to the alignment of a discrete rocker value on a conventional engine. Accordingly, in the preferred embodiment, measuring to the center of the aperture, from the either edge of the base cover 10, the outermost adjustment hole 11 is 2 5/16″ from the edge, with the second adjustment hole 11 moving in being 1¾ inch from the outermost adjustment hole 11, the third adjustment hole 11 moving in being 2 13/16″ inch from the second adjustment hole 11, the fourth adjustment hole 11 moving in being 1¾ inch from the third adjustment hole 11, and the two fourth adjustment hole 11 from the opposing edges being 2 13/16″ inch from one another.

The base cover 10 includes a bottom rolled edge 12 that defines its bottom profile, extending out from its side surfaces. In the preferred embodiment, the base cover 10 is constructed of 0.04″ thick stamped steel, with a top profile measuring 19 11/16″ by 4″ by 2½″ and bottom profile measuring 19 11/16″ by 5″0 by 2½″.

Four cinch holes 13 define apertures in the rolled edge 12 that may be used with elongated fasteners (not shown) to attach the base cover to an engine. In the preferred embodiment, the cinch holes 13 are each positioned 5⅜″ from the corner of the base cover 10.

Each removable plug 20 defines an elastic member sized to be removably placed in one of the adjustment holes 11. In the preferred embodiment, each removable plug 20 is constructed of rubber and includes a top section 21 with a 1½″ diameter, a mid section 22 with a 1″ diameter, a latch section 23 with a diameter that extends out to 1¼, and a bottom section 24 with a 1″ diameter. It is contemplated that the latch section 23 is operative to secure the removable plug 20 an adjustment hole 11 due to its increased diameter, while still allowing the removable plug 20 to be removed from or inserted into an adjustment hole 11 through the application of manual force due to its 45 degree angular rise/fall from the mid section 22 and bottom section 24, respectively, and the deformable nature of the material it is constructed of.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A rocker valve adjustment cover, comprising:
a base cover sized to be placed on a conventional engine, wherein said base cover defines a rigid enclosure having four connected side surfaces connected at one end to a top surface, and a plurality of adjustment holes positioned on the top surface and in locations that correspond to the alignment of discrete rocker valves on a conventional engine on which the base cover is placed; and
a plurality of removable plugs, each defining an elastic body adapted to be removably secured into one of said adjustment holes.

2. The rocker valve adjustment cover of claim 1, wherein said base cover additionally includes a bottom rolled edge that defines extends out from the side surfaces at the end opposite the top surface.

3. The rocker valve adjustment cover of claim 2, wherein the rolled edge includes at least one cinch hole for securing the base cover to a conventional engine.

4. The rocker valve adjustment cover of claim 3, wherein the rolled edge includes four cinch holes.

5. The rocker valve adjustment cover of claim 2, wherein the base cover includes eight discrete adjustment holes, each positioned to in a location that correspond to the alignment of a single rocker valve.

6. The rocker valve adjustment cover of claim 1, wherein the base cover includes eight discrete adjustment holes, each positioned to in a location that correspond to the alignment of a single rocker valve.

7. The rocker valve adjustment cover of claim 6, wherein the removable plugs each include a top section, mid section, latch section, and bottom section, thereby configuring it to be securable in a single adjustment hole while still allowing the removable plug to be removed from or inserted into an adjustment hole through the application of manual force.

8. The rocker valve adjustment cover of claim 1, wherein the removable plugs each include a top section, mid section, latch section, and bottom section, thereby configuring it to be securable in a single adjustment hole while still allowing the removable plug to be removed from or inserted into an adjustment hole through the application of manual force.
